(19) United States
(12) Patent Application Publication
(10) Pub. No.: US 2020/0349631 A1
(43) Pub. Date: Nov. 5, 2020

(54) System and Method for Eyewear Recommendation

(71) Applicant: NWO Group Pty Ltd, West Melbourne (AU)

(72) Inventor: Jinsheng Long, Mitcham (AU)

(21) Appl. No.: 16/757,636

(22) PCT Filed: Oct. 19, 2018
(86) PCT No.: PCT/AU2018/051139

§ 371 Date: Apr. 20, 2020

(30) Foreign Application Priority Data
Oct. 19, 2017 (AU) 2017904227

(51) Int. Cl. G06Q 30/06; G06F 3/0482; G06T 7/50; G06T 11/60

(52) U.S. Cl. CPC G06Q 30/0631; G06F 3/0482; G06T 7/50; G06T 2207/10024; G06Q 30/0621; G06Q 30/0643; G06T 2207/30201; G06T 11/60

(57) ABSTRACT

A computer-implemented method (300) for eyewear recommendation and sales, comprising: electronically receiving a captured image of a user (302); analysing the user's face shape based on the image (304); identifying frames compatible with results of the face shape analysis (310); analysing the user's skin colour based on the image (312); identifying frames compatible with results of the skin colour analysis (324); computing shortlist of suggested eyeware based on frames identified as being compatible with face shape and skin colour (326); receiving user selection of eyeware from the shortlist (328); and, computing a price of user selection (330).

### FIELD

In a particular aspect, the present invention relates to computer-implemented methods and systems for eyewear recommendations and sales.

### BACKGROUND

Marketing, recommending, and selling prescription eyewear requires complex technical expertise. The sales person needs to have extensive knowledge of a wide variety of frames, lenses, contact lenses, etc, to be able to effectively recommend suitable combinations and permutations of eyewear for each customer. Extensive technical training, product knowledge and experience are required for a sales person to become effective and productive. Currently, training for eyewear sales takes between one to two years. Due to the commitment involved, a limited number of people are being trained, and the demand for trained dispensers currently outstrips supply.

Customers often find it difficult to understand the differences in eyewear technology and the complex technical information and factors that must be taken into account when selecting eyewear. Further, because customers cannot view the end product, they are heavily reliant on the knowledge and skills of the sales person. The complexity of the product and variable competency of sales people often results in errors and variable results in sales staff performance. This results in underperformance, lost sales and customer dissatisfaction.

In this context, there is a need for a system and method to assist sales people with recommending, dispensing, and selling complex eyewear products, and/or that streamlines and simplifies the decision-making process for the customer.

### SUMMARY

According to the present invention, there is provided a method comprising:

receiving, at a processor, a user's optical prescription;

receiving, at the processor, the user's frame preferences based on one or more user-specified criteria selected via a user device;

computing, by the processor, a shortlist of suggested frames based on the user's frame preferences;

displaying, on the user device, information relating to the shortlist of suggested frames;

receiving, at the processor, a user-selected frame selected from the shortlist of suggested frames via the user device;

receiving, at the processor, the user's lens preferences based on one or more user-specified criteria selected via the user device;

computing, by the processor, a shortlist of available lenses corresponding to the user's lens preferences, the user's optical prescription and suitability for fitting to the user-selected frame;

displaying, on the user device, the shortlist of lenses;

receiving, at the processor, user-selected lenses selected from the shortlist via the user device;

computing, by the processor, a total price of user-selected frame and user-selected lenses; and

displaying, on the user device, the total price.

The processor may retrieve the user's optical prescription from a database.

The processor may receive the user's optical prescription from user input via the user device.

The user-specified criteria for computing frame preferences may comprise one or more of frame style, user lifestyle, frame brand, intended use, age of user, comfort, frame material, frame durability, frame weight, frame size, user's health conditions, strength of prescription, frame price, user's face shape, user's skin colour and other facial features of the user.

The method may further comprise:

receiving, at the processor, a photograph of the user;

analysing, by the processor, the user's face shape and/or skin colour based on the photograph;

displaying analysis results of the user's face shape and/or skin colour; and

applying the analysis results when shortlisting the suggested frames.

The analysis of face shape may be computed by:

identifying a plurality of facial landmarks based on the photograph;

computing a plurality of classifications relating to the facial landmarks; and

identifying frames compatible with the classifications.

The facial landmarks may include a hairline, jawline, skull shape, eye position, eye shape, eye colour, nose position or nose outline of the user.

The classifications relating to skull shape may include oval, oblong, heart, square, round, diamond or triangle shaped.

The classifications relating to jawline may include point, square or round.

The analysis of skin colour may be computed by:

comparing one or more identified colour sample values with a colour scale; and

computing a scale value for each colour sample value.

The colour scale may comprise a Von Luschan's chromatic scale.

The analysis of skin colour may further comprise computing a skin tone classification for each scale value according to a phototyping scale.

The phototyping scale may comprise a Fitzpatrick phototyping scale.

The photograph of the user may be captured by a camera of the user device.

The user-specified criteria for computing lens preferences may comprise one or more of lens design, lens coating, lens material, lens thickness, lens price, lens tint, lens photochromic treatment, lens coatings, lens durability, lens edge finish, strength of prescription, user lifestyle, lens brand, intended use, age of user, comfort, and user's health conditions.

The method may further comprise displaying, on the user device, a simulation of a user-selected lens type.

The step of computing the shortlist of frames and/or the step of computing the shortlist of lenses may further comprise applying a predictive model based on similar customers according to the user-specified criteria.

The step of computing the shortlist of frames and/or the step of computing the shortlist of lenses may further comprise predictive analysis of the user's price sensitivity based on the user's purchasing history.

The step of computing the shortlist of frames and/or the step of computing the shortlist of lenses may further comprise predictive analysis of the user's purchasing behaviours and social preferences.

The method may further comprise:

displaying, on the user device, one or more additional features available for the user-selected frame and/or user-selected lenses;

selecting, via the user device, one or more of the additional features;

re-computing, by the processor, an updated total price of user-selected frame and lenses together with the additional feature(s); and

displaying, on the user device, the updated total price.

The method may further comprise displaying one or more offers, advertisements or promotional images on the user device.

The present invention also provides a system comprising: a processor; and

a non-transitory computer-readable medium coupled to the processor and having instructions stored thereon, which, when executed by the processor, cause the processor to perform operations comprising:

receiving, at the processor, a user's optical prescription;

receiving, at the processor, the user's frame preferences based on one or more user-specified criteria selected via a user device;

computing, by the processor, a shortlist of suggested frames based on the user's frame preferences;

displaying, on the user device, information relating to the shortlist of suggested frames;

receiving, at the processor, a user-selected frame selected from the shortlist of suggested frames via the user device;

receiving, at the processor, the user's lens preferences based on one or more user-specified criteria selected via the user device;

computing, by the processor, a shortlist of available lenses corresponding to the user's lens preferences, the user's optical prescription and suitability for fitting to the user-selected frame;

displaying, on the user device, the shortlist of lenses;

receiving, at the processor, user-selected lenses selected from the shortlist via the user device;

computing, by the processor, a total price of user-selected frame and user-selected lenses; and

displaying, on the user device, the total price.

The present invention also provides a non-transitory computer-readable medium having instructions stored thereon, which, when executed by a processor, cause the processor to perform operations comprising:

receiving, at the processor, a user's optical prescription;

receiving, at the processor, the user's frame preferences based on one or more user-specified criteria selected via a user device;

computing, by the processor, a shortlist of suggested frames based on the user's frame preferences;

displaying, on the user device, information relating to the shortlist of suggested frames;

receiving, at the processor, a user-selected frame selected from the shortlist of suggested frames via the user device;

receiving, at the processor, the user's lens preferences based on one or more user-specified criteria selected via the user device;

computing, by the processor, a shortlist of available lenses corresponding to the user's lens preferences, the user's optical prescription and suitability for fitting to the user-selected frame;

displaying, on the user device, the shortlist of lenses;

receiving, at the processor, user-selected lenses selected from the shortlist via the user device;

computing, by the processor, a total price of user-selected frame and user-selected lenses; and

displaying, on the user device, the total price.

In another aspect, the invention provides a method comprising:

receiving, at a processor, a photograph of a user;

analysing, by the processor, the user's face shape and/or skin colour based on the photograph; and

computing, by the processor, a shortlist of suggested frames based on results of the analysis of the user's face shape and/or skin colour.

The analysis of face shape may be computed by:

identifying a plurality of facial landmarks based on the photograph;

computing a plurality of classifications relating to the facial landmarks; and

identifying frames compatible with the classifications.

The facial landmarks may include a hairline, jawline, skull shape, eye position, eye shape, eye colour, nose position, face height, face width and/or nose outline of the user.

The classifications relating to face shape may include oval, oblong, heart, square, round, diamond and/or triangle shaped.

The classifications relating to jawline may include pointy, square and round.

The classifications relating to hairline may include wide, intermediate and narrow.

The user's face shape may be determined based on: a face height to width comparison value, hairline classification, and jawline classification.

The analysis of skin colour may comprise:

cropping one or more sample areas from the user's face as depicted in the photograph; and

calculating a colour sample value for the average colour of the one or more sample areas.

The cropped sample areas may be from the user's right cheek, left cheek, and/or forehead in the photograph.

The analysis of skin colour may further comprise:

comparing the identified colour sample value with a colour scale; and

computing a scale value for the colour sample value.

The colour scale may comprise a Von Luschan's chromatic scale.

The analysis of skin colour may further comprise computing a skin tone classification for the scale value according to a phototyping scale.

The phototyping scale comprises a Fitzpatrick phototyping scale

The method may comprise capturing the photograph of the user.

The method may further comprise:

receiving, at the processor, a user-selected frame selected from the shortlist of suggested frames displayed on a user device; and

computing, by the processor, a total price of user-selected frame (which may include eyewear having such a frame) for display on the user device.

The method may further comprise:

receiving, at the processor, the user's frame preferences based on one or more user-specified criteria; and

computing, by the processor, the shortlist of suggested frames based on the user's frame preferences and results of the analysis of the user's face shape and/or skin colour.

The method may further comprise:

receiving, at the processor, the user's optical prescription;

receiving, at the processor, a user-selected frame selected from the shortlist of suggested frames displayed on a user device;

receiving, at the processor, the user's lens preferences based on one or more user-specified criteria selected via the user device;

computing, by the processor, a shortlist of available lenses corresponding to the user's lens preferences, the user's optical prescription and suitability for fitting to the user-selected frame;

receiving, at the processor, user-selected lenses selected from the shortlist of lenses displayed on the user device;

computing, by the processor, a total price of user-selected frame and user-selected lenses for display on the user device.

In another aspect, the invention provides a system, comprising: a processor;

and a non-transitory computer-readable medium coupled to the processor and having instructions stored thereon, which, when executed by the processor, cause the processor to perform operations comprising:

receiving, at a processor, a photograph of a user;

analysing, by the processor, the user's face shape and/or skin colour based on the photograph; and

computing, by the processor, a shortlist of suggested frames based on results of the analysis of the user's face shape and/or skin colour.

In another aspect, the invention provides a non-transitory computer-readable medium having instructions stored thereon, which, when executed by a processor, cause the processor to perform operations comprising:

receiving, at a processor, a photograph of a user;

analysing, by the processor, the user's face shape and/or skin colour based on the photograph; and

computing, by the processor, a shortlist of suggested frames based on results of the analysis of the user's face shape and/or skin colour.

It is to be appreciated that various means and/or steps listed herein may be omitted or combined in forming alternative systems, mediums, or methods in accordance with the invention.

### BRIEF DESCRIPTION OF DRAWINGS

Embodiments of the invention will now be described by way of example only with reference to the accompanying drawings, in which:

FIG. 1 is a functional block diagram of a system according to one embodiment of the present invention for implementing the method for eyewear recommendation and sales;

FIG. 2 is a flowchart of the computer-implemented method according to embodiments of the present invention;

FIGS. 3 to 16 are example user interfaces generated by the method;

FIG. 17 is a diagram of a face landmark detection points array;

FIG. 18 is a diagram showing a fairly typical hairline arc;

FIG. 19 is a table of factors and their values used in the determination of hairline type;

FIG. 20 is a table of factors and their values used in the determination of jawline type;

FIG. 21 is a table of factors and their values used in the determination of face shape;

FIG. 22 is a diagram illustrating cropping of facial areas used in determining skin colour; and

FIG. 23 is a table of von Luschan and Fitzpatrick scale values used in the determination of skin type; and

FIG. 24 is a flowchart of a computer-implemented method for eyewear recommendation and sales according to a second embodiment of the invention

### DESCRIPTION OF EMBODIMENTS

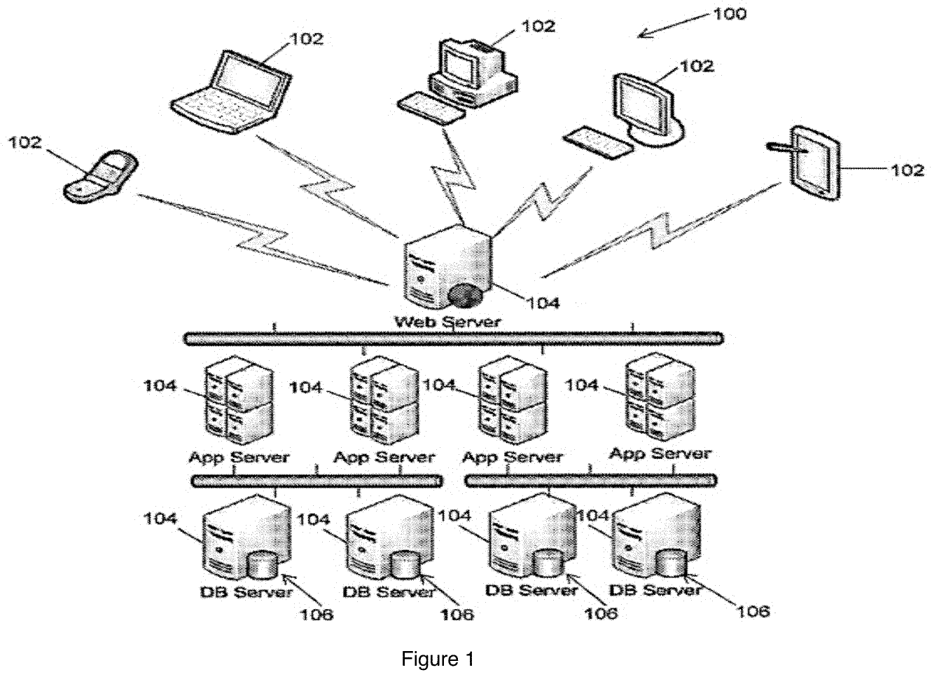

Referring to FIG. 1, a computer-implemented method (200) for eyewear recommendation and sales according to an embodiment of the present invention may be implemented in a system 100 as web and/or mobile software applications comprising one or more computer program modules executable by one or more computing/user devices 102 associated with users of the system that communicate via a network with one or more servers 104 and associated databases 106. The user devices 102 may comprise desktop computers, laptop computers, tablet computers, smartphones, and combinations thereof. The method 200 may be provided as Saas (Software as a Service) to consumers who register as users of the system 100, such as eyewear retailers (including online eyewear retailers and stores), optometrists, opticians, or may directly target eyewear customers.

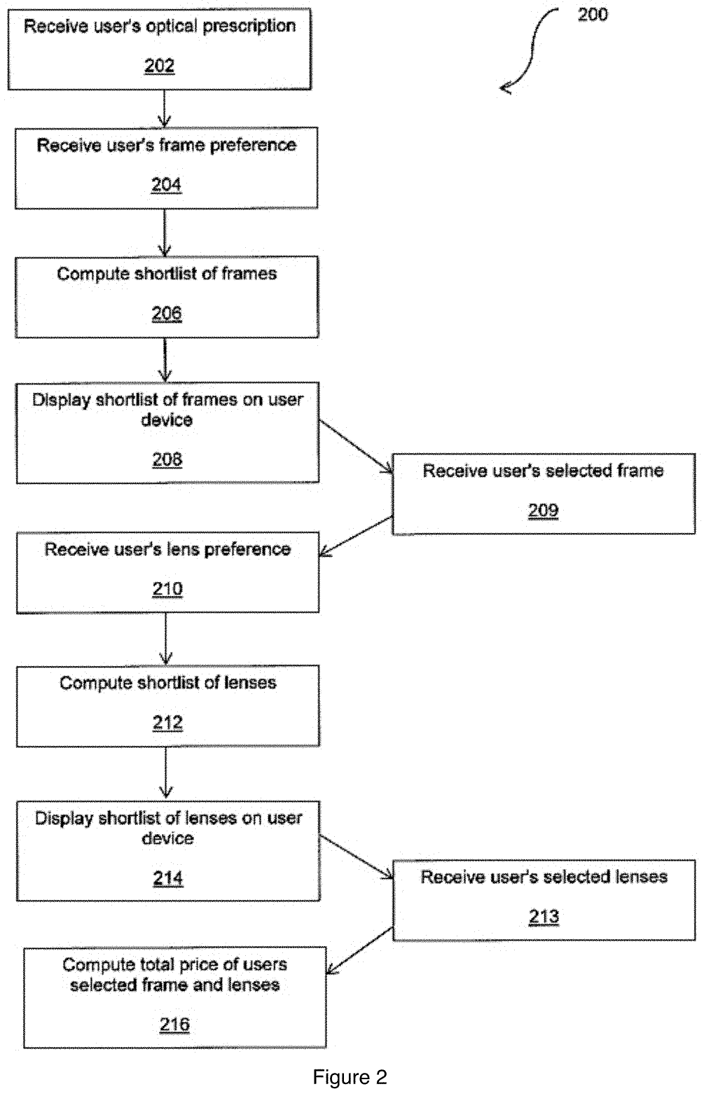

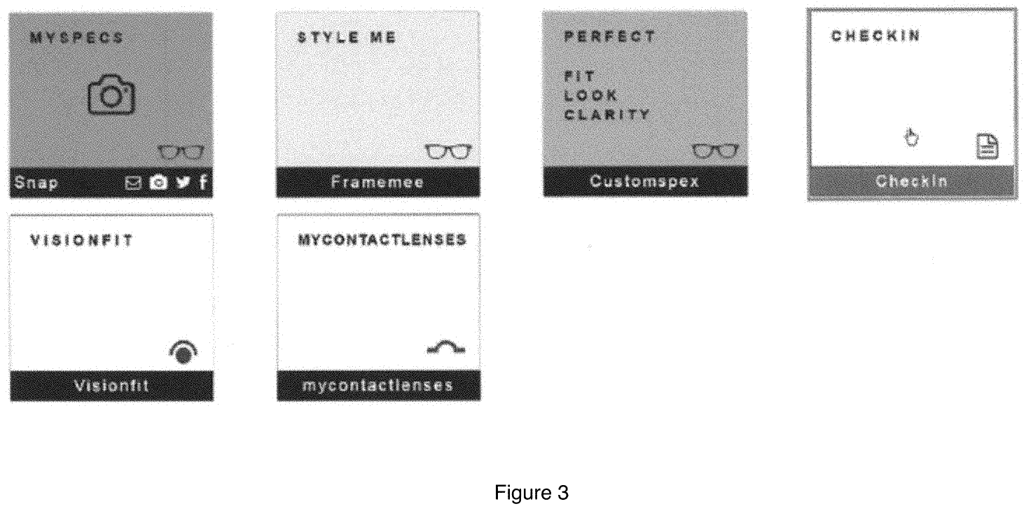

According to one embodiment illustrated in FIG. 2, the method (200) begins at step (202) by receiving, at server 104, a user's optical prescription. In one example scenario, the method may be implemented at an eyewear retail store, and the user device 102 may be a desktop computer operated by a sales person to enter a customer's details while serving the customer. The term “user” in this context therefore refers generally to the customer but the user's details may be physically entered or selected via the user device by the sales person entering data on behalf of the customer.

In one further example scenario, the method may be implemented by an online eyewear store and the user device 102 may be a desktop computer or mobile device operated by a customer who connects to, and accesses, the online eyewear store via the internet.

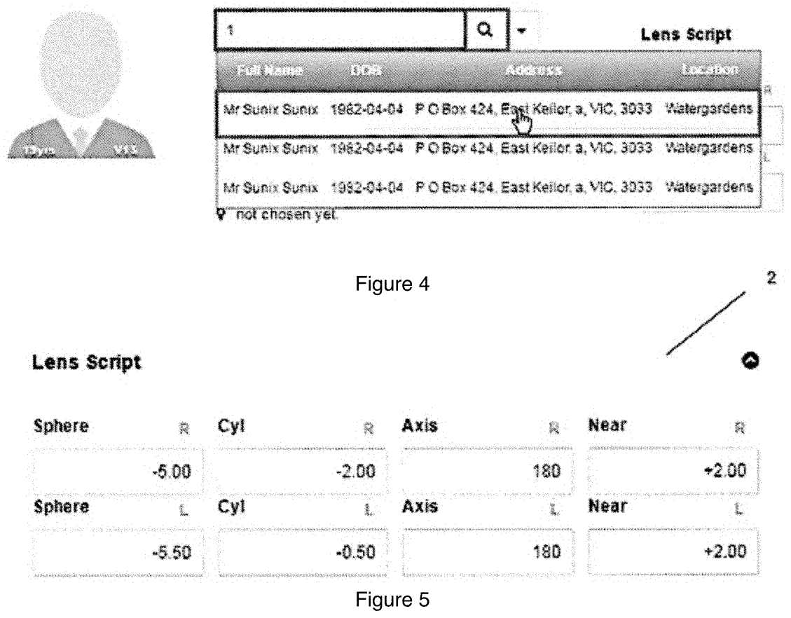

As illustrated in FIG. 4, the customer's records may be retrieved from a database. The customer's optical prescription may also be retrieved from the customer's records stored on the database. Alternatively, as illustrated in FIG. 5, the customer's optical prescription 2 may be entered via the user device.

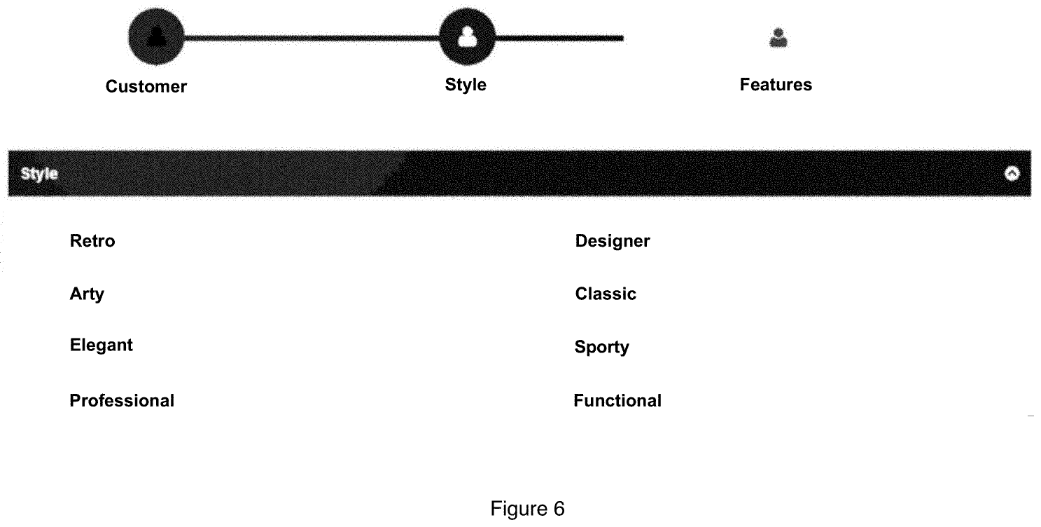

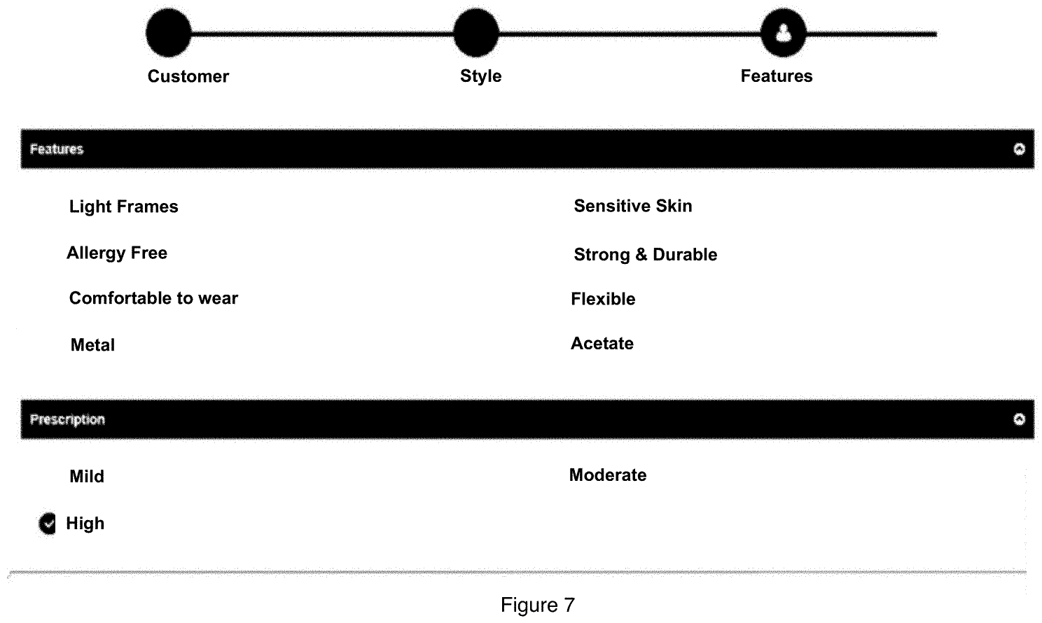

Next, at (204), the user's frame preferences are received at the server. The user's frame preferences may be based on one or more user-specified criteria selected via the user device 102, or alternatively, may be retrieved from the user's records such as the user's purchasing history. The user-specified criteria 4 may comprise, for example, frame style, user lifestyle, frame brand, intended use, age of user, comfort, frame material, frame durability, frame weight, frame size, user's health conditions, strength of prescription, frame price, user's face shape, user's skin colour and other facial features of the user. Example user interfaces shown in FIGS. 6 and 7 illustrate several of these criteria. In some embodiments, described in more detail below, facial analysis may be used to determine the user's face shape, skin colour or other facial features.

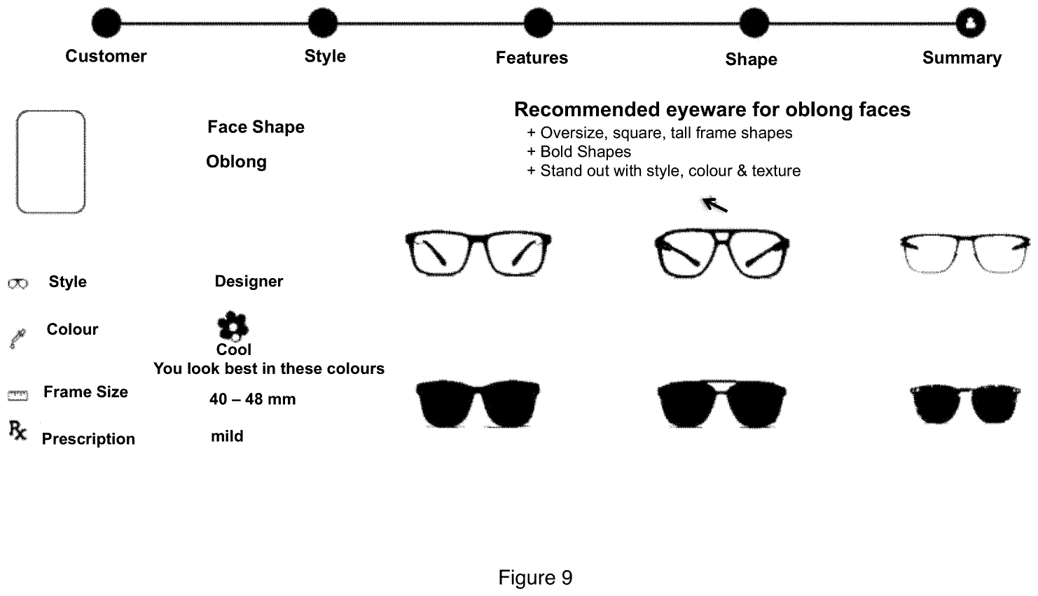

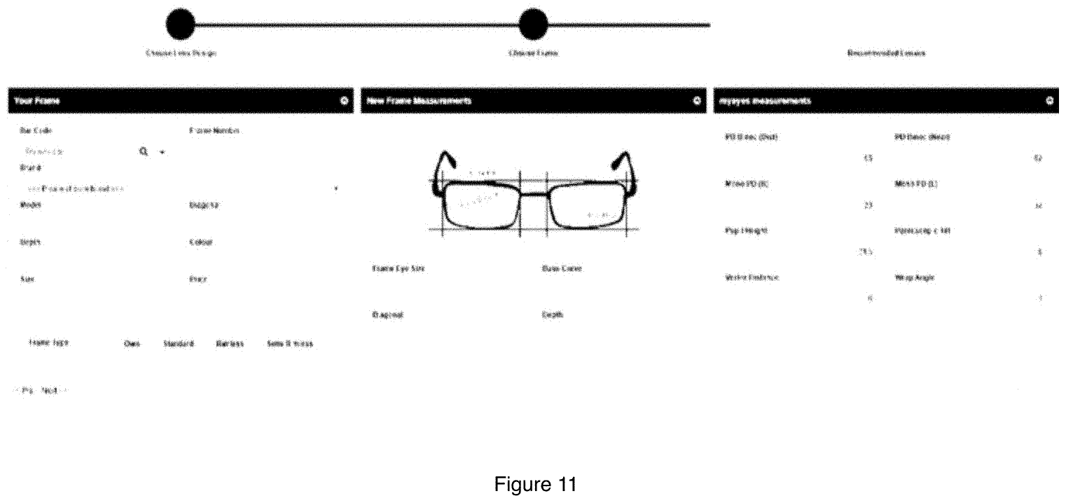

The method (200) then computes, by a processor of the server, a shortlist of suggested frames 6 based on the user's frame preferences at step (206). The complete list of frames from which the shortlist is selected may be stored on database 106, and may correspond to all the frames available at a retail store and/or available for order from a manufacturer or supplier. Next, at (208), information relating to the shortlist of frames 6 may be displayed on the user device, as illustrated in FIG. 9. The user may then select a frame from the shortlist via the user device 102, and the user-selected frame is received at the server at step (209). Details of the user-selected frame may be entered by the sales person via the user device, or may be automatically generated by the system as illustrated in FIG. 11. The customer's measurements may also be entered into the system, or may be retrieved from the customer's records, and may be useful for ordering a customised frame according to the user's style preferences and any other specific needs of the user.

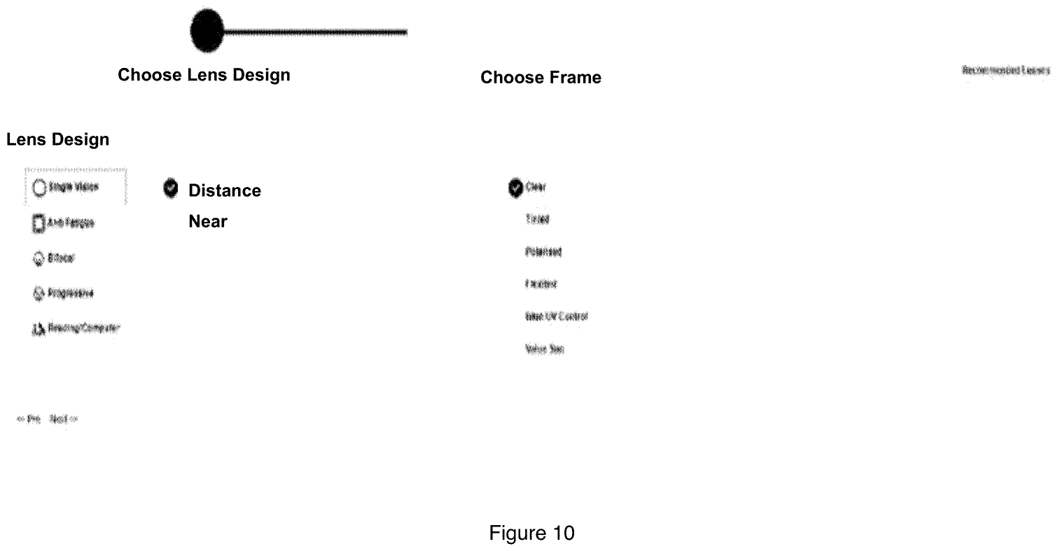

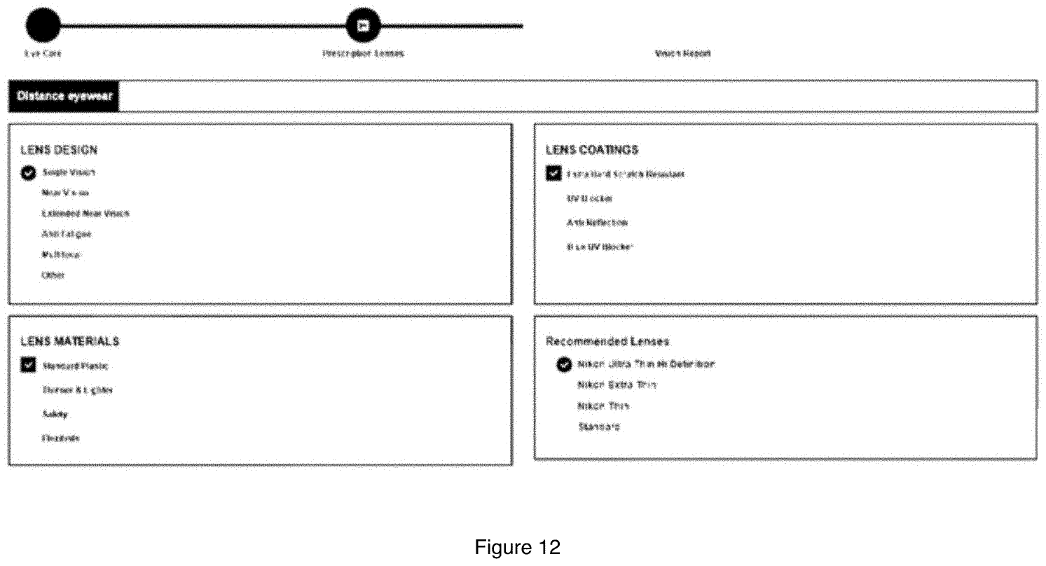

Next, at (210), the user's lens preferences are received at the server. The user's lens preferences may be based on one or more user-specified criteria 8 selected via the user device 102, or alternatively, may be retrieved from the user's records such as the user's purchasing history. The user-specified criteria may comprise one or more of lens design, lens coating, lens material, lens thickness, lens price, lens tint, lens photochromic treatment, lens coatings, lens durability, lens edge finish, strength of prescription, user lifestyle, lens brand, intended use, age of user, comfort, and user's health conditions. Example user interfaces shown in FIGS. 10 and 12 illustrate several of these criteria.

The method then computes at step (212) a shortlist of available lenses corresponding to the user's lens preferences, the user's optical prescription and the size, shape and profile of the user-selected frame. As will be appreciated, there are typically many combinations of lenses and frames that would match these criteria, but there are also many combinations that would be difficult, costly or impossible to be manufactured, e.g. if the preferred type of lens is too thick, heavy or curved for the user-selected frame, is outside the power range for the lens blank size or the frame is too large for the lens blank size. The system 100 assesses the various combinations and permutations, and displays only the possible options (or a subset of the possible options), so that the sales person does not need to have extensive technical knowledge of all the available frames or lenses in order to be able to effectively and confidently recommend suitable total eyewear packages to the customer. This advantageously creates productivity gain, speeds up the dispensing process and provides price transparency for the user.

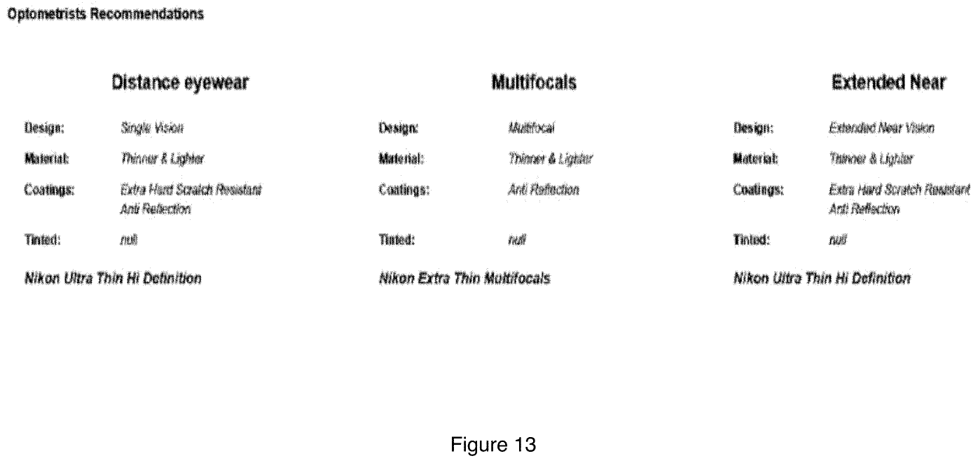

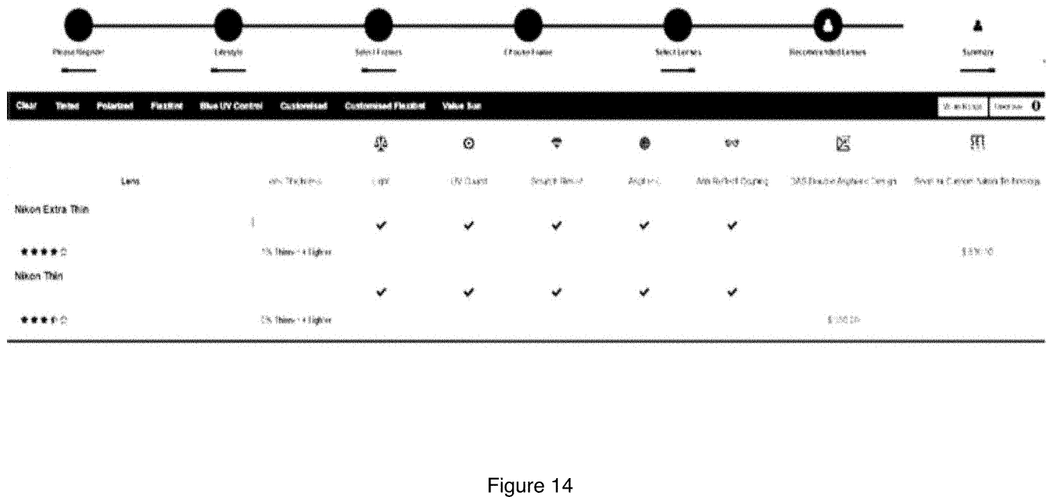

Next, at (214), the shortlist of lenses may be displayed on the user device, as illustrated in FIGS. 13 and 14. In some embodiments, the shortlist of lenses (or a subset of lenses selected by the user from the shortlist) may be displayed in a comparison table, e.g. as illustrated in FIG. 14, to enable the customer to conveniently and visually compare the different features of each lens. For example, the table illustrated in FIG. 14 includes an indication of the thickness of the lens, selected features of each lens and the price of each lens. Additional lens features and properties may also be displayed making it simple and easy to understand for the user. The information selected by the user and which is used by the method to form the shortlist of lenses may also conveniently displayed on the user device (for example, at the bottom of the screen) to allow the sales person to cross refer back to the user's preferences. The user may then select a pair of lenses from the shortlist via the user device 102, and the user-selected lenses are received at the server at step (213).

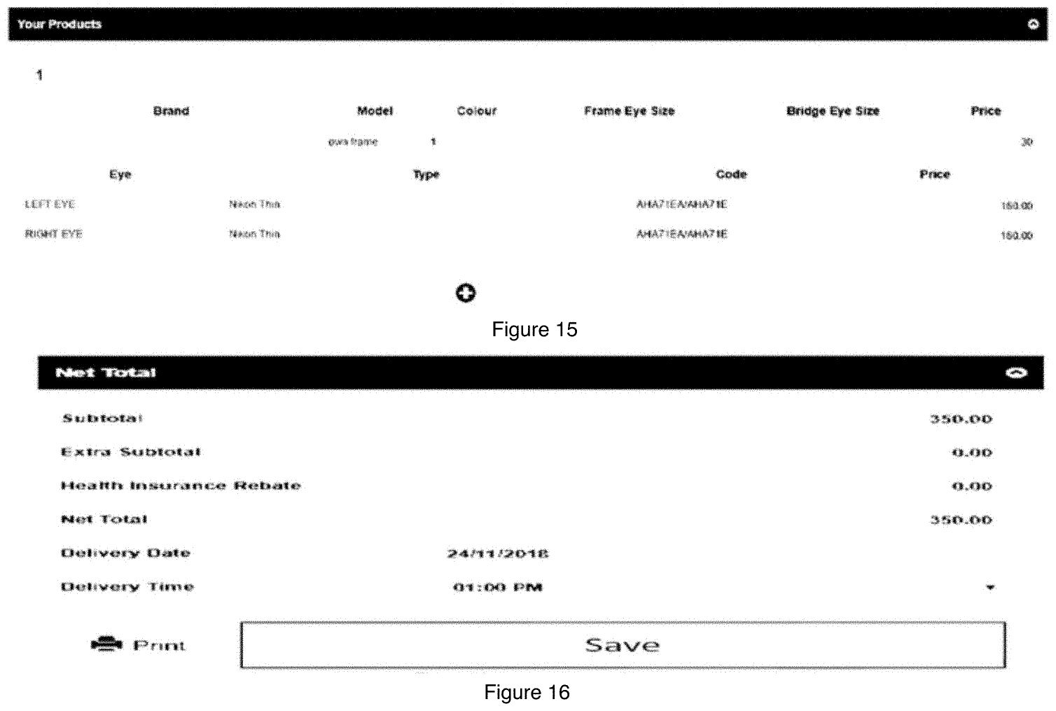

Next, at step (216) the processor computes the total price of the user-selected frame and user-selected lenses and displays the total price on the user device, as illustrated in FIGS. 15 and 16. The method provides that the total price is calculated accurately and, in addition to the user-selected frame and lenses, the method may take into account availability of frame and lens stock and any special orders or offers applicable to the relevant frame or lenses and/or to the user. In addition to the total price, the method may also display on the user device information demonstrating the savings and value afforded to the user in relation to the user-selected frame and lenses. For example, information relating to any special orders or offers applied when calculating the total price or one or more price comparisons may be displayed.

In some embodiments, the method allows for modifications to the customer's order and automatically updates details (e.g. price) of the eyewear package. For example, the method may include displaying and selecting one or more additional or modifiable features available for the user-selected frame and/or user-selected lenses on the user device. Additionally, or alternatively, the method may allow for additional eyewear packages to be added to the order (as illustrated in FIG. 15) by repeating the process described above. Preferably, the method (200) then re-computes, by the processor, the updated total price of user-selected frame and lenses together with the additional feature(s) and/or additional frame and lenses and lens properties, and displays the updated total price on the user device.

In some embodiments, the system may also comprise functionality that enables the user to purchase a second pair of glasses according to the user's selected frame, lens and other preferences at a discounted price.

The system may additionally be linked to one or more manufacturer or supplier ordering systems, to automatically transmit the customer's order once confirmed by the customer. For example, the system may be connected to one or more third-party provided payment systems or gateways that enable sale transactions to be completed securely and conveniently online. This may include a payment system that offers a credit facility enabling customers to complete a purchase and pay for the relevant goods at a later date.

In some embodiments, the method may further comprise associating a completed sales process with the responsible sales person in order to track a performance indicator and provide a method for customer retention, e.g. a net promoter score or customer satisfaction score linked to the sales person may be computed as part of the method. This advantageously enables customer satisfaction (or dissatisfaction) to be identified and recorded.

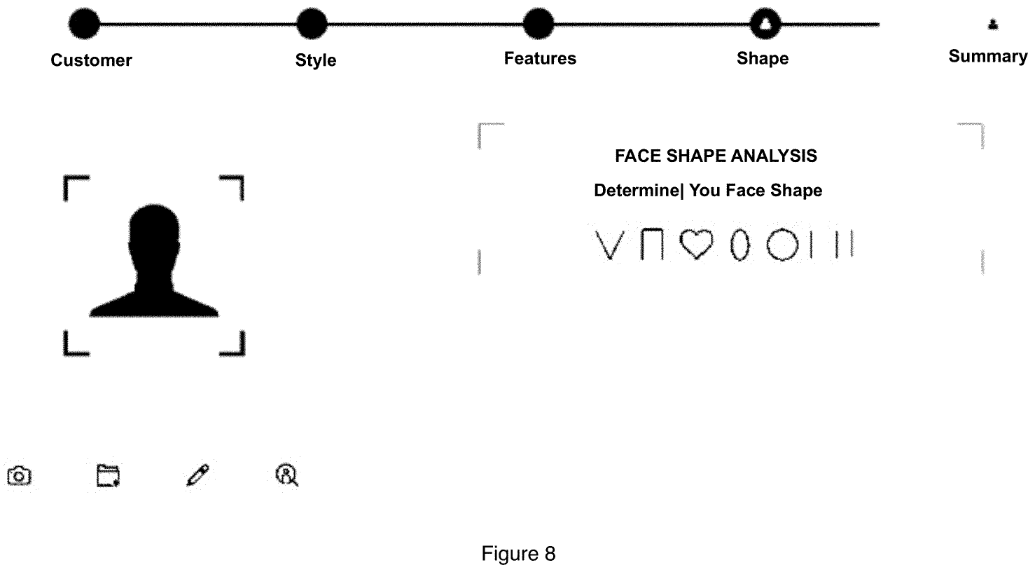

In some embodiments, as illustrated in FIGS. 8 and 9, the system may be used to perform a facial analysis of the customer to assess the user's face shape, skin colour or other facial features, for use in computing and shortlisting recommended frames. Accordingly, in some embodiments, the method 200 may further comprise receiving, at the processor, a photograph/image of the user, analysing the user's face shape and/or skin colour based on the photograph/image, displaying the analysis results of the user's face shape and/or skin colour (as illustrated in FIG. 9) and applying the analysis results when shortlisting the suggested frames. In some embodiments, the photograph/image of the user is captured on the spot by a camera associated with the user device. This may be preferable as the camera would be calibrated with the surrounding environment for effective facial analysis. Alternatively, the user may upload a photograph/image, or the system may retrieve a saved photograph/image of the user for analysis.

In some embodiments, the face shape analysis may be performed by identifying a plurality of facial landmarks based on the photograph/image, computing a plurality of classifications relating to the facial landmarks and then identifying frames compatible with the classifications. The facial landmarks may include a hairline, jawline, skull shape, eye position, eye shape, eye colour, nose position or nose outline of the user. The classifications relating to jawline may include point, square or round. The classifications relating to face shape may include oval, oblong, heart, square, round, diamond or triangle.

The analysis of skin colour may be computed by comparing one or more identified colour sample values with a colour scale (such as, for example, a Von Luschan's chromatic scale) and then computing a scale value for each colour sample value. The analysis of skin colour may further comprise computing a skin tone classification for each scale value according to a phototyping scale such as, for example, a Fitzpatrick phototyping scale.

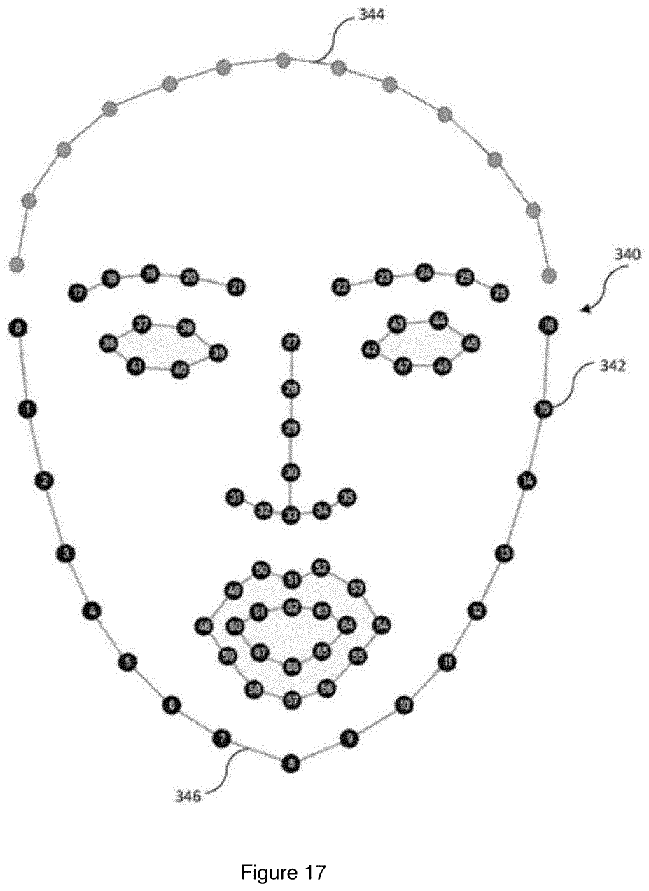

In a particular embodiment, human face landmarks can be recognized by open source dlib API. As shown in FIG. 17, the dlib face landmark detect API can recognize an array, generally designated 340, of sixty-eight facial landmark points 342 numbered from zero to sixty-seven.

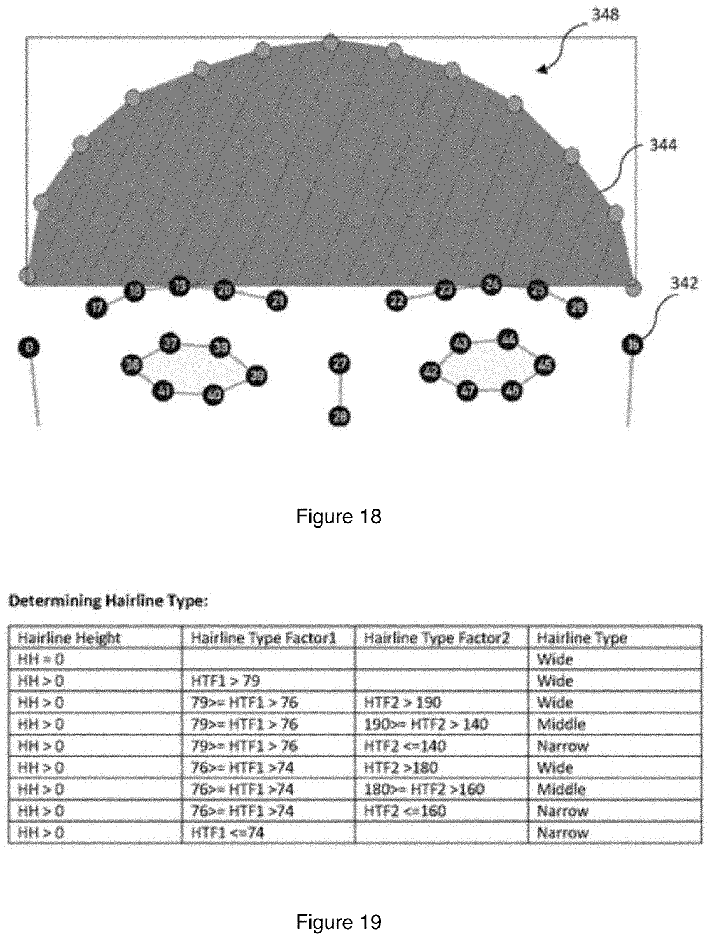

In a particular embodiment, as shown in FIG. 18, the hairline 344 is identified, in addition to facial landmarks identified using the dlib face landmark points, in order to determine face shape. Identifying the hairline may involve the following steps:

1. Crop a rectangle area containing the face according to the face landmarks points and calculate the average gray level of the face area;
2. Make/provide brightness contrast on the face area according to the gray level (using ImageMagick, a free and open-source software suite for displaying, converting, and editing master image and vector image files);
3. Make/provide contrast again on the face area (using ImageMagick);
4. Make/provide canny edge detection on the treated image (Canny Edge Detection is an edge detection algorithm developed by John F. Canny in 1986).
5. Read the white edge of the hairline between face landmark point zero and point sixteen in order to obtain the point array, generally designated 348, of the hairline called the HairlinePoint (HP).

Various formulas which can be used in determining hairline and face shape are provided below.

A formula for determining face height is as follows:

$$Face Height = {m}_{l} ax \{ abs {(}_{k} max \{ Point [ k ] \cdot Y - HP [ l ] \cdot Y ) \}$$

l=0 . . . Upper index of hairline point
k=0 . . . 16

A formula for determining face width is as follows:

$$Face Width = {m}_{k} ax \{ abs ( Point [ k ] \cdot X - Point [ 16 - k ] \cdot X ) \}$$

k=0 . . . 7

A formula for determining hairline height (HH) is as follows:

HH=abs(max{HP[k]·Y}−min{HP[k]·Y})

A formula for determining hairline width (HW) is as follows:

HW=abs(max{HP[k]·X}−min{HP[k]·X})

A formula for determining hairline rectangle container area (HRCA) is as follows:

HRCA=HH*HW

A formula for determining hairline outline area (HOA) is as follows:

$$HOA = {\sum }_{k = 1}^{\text{?}} \frac{1}{2} * ( abs ( HP [ k ] , Y - HP [ 0 ] , Y ) + abs ( HP [ k - 1 ] , Y - HP [ 0 ] , Y ) ) * abs ( HP [ k ] - HP [ k - 1 ] )$$

$$\text{?} \text{indicates text missing or illegible when filed}$$

Formulas for determining hairline type factor (HYF) are as follows:

$$HYF 1 = \frac{HOA}{HRCA} * 100$$

$$HYF 2 = HYF 1 * \frac{HW}{HH}$$

As shown in the table of FIG. 19, the hairline type can be calculated as either wide, narrow, or middle (intermediate), based on the hairline height, hairline type factor 1, and hairline type factor 2.

In a particular embodiment, the jawline/chin type 346 (see FIG. 17) can be determined by the angle change of the landmark points 3 to 13. By taking point [7], point [8] and point[9], point [8] being the central point, the two sides of the central point's angle can be calculated. The distance between two points can be calculated by the following formula:

$$D ( P 1 , P 2 ) = \sqrt[\text{?}]{{( P 1 \cdot X - P 2 \cdot X )}^{2} + {( P 1 \cdot Y - P 2 \cdot Y )}^{2}}$$

$$\text{?} \text{indicates text missing or illegible when filed}$$

Calculating the three edges of three points can be performed using the following formula:

DIₖ=D(Point[8−k],Point[8])

D2ₖ=D(Point[8],Point[8+k])

D3ₖ=D(Point[8+k],Point[7])

Calculating the angle of the central point can be performed using the following

$${θ}_{k} = \frac{100 * {cos}^{- 1} \frac{D {1}_{k}^{2} + D {3}_{k}^{2} - D {2}_{k}^{2}}{2 * D {1}_{k} * D {3}_{k}}}{π}$$

Calculating the jawline/chin type factor can be performed as follows:

$${f}_{k} = {θ}_{k} \frac{HW}{HH}$$

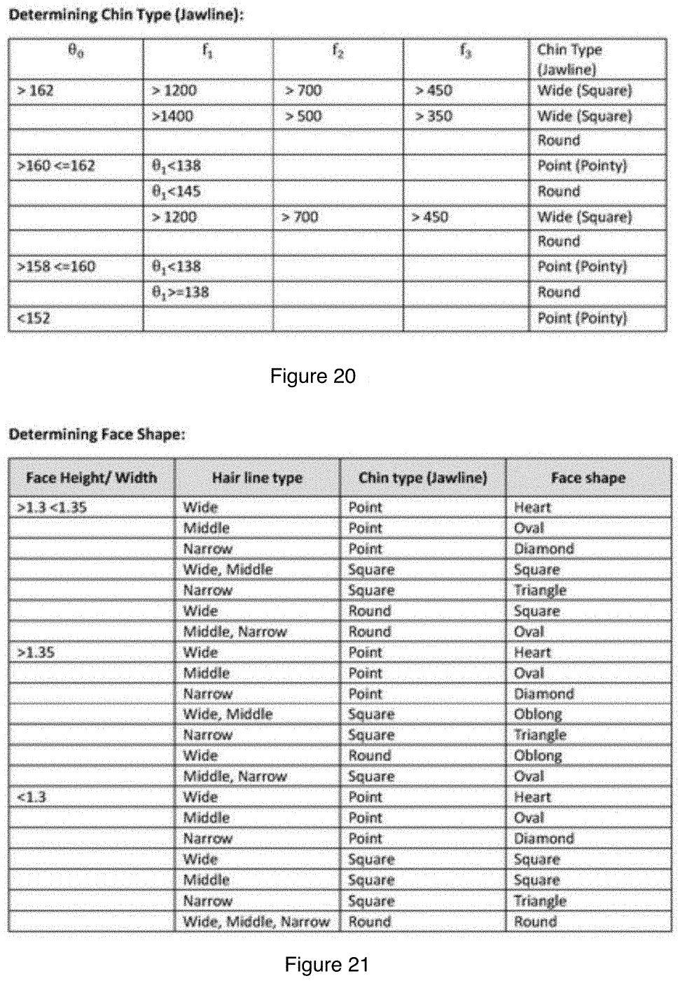

As shown in the table of FIG. 20, the jawline/chin type can be identified as either wide/square, round, or point/pointy.

In a particular embodiment, the face shape is identified as follows:
1. Upload face picture file into server, use DLIB API detect face to obtain facial landmark points;
2. Use canny edge detection to detect the hairline from the head area according the facial landmark points;
3. Classify the jawline/chin according to the facial landmark points as Point, Square, Round;
4. Classify the hairline as Wide, Middle/Intermediate, Narrow;
5. Identify the face shape—as shown in the table of FIG. 21, the face shape can be identified as either heart, oval, diamond, square, triangle,
6. oblong or round based on the ratio of face height to width, the hairline type, and the chin type.

In a particular embodiment, the user's eye colour can be determined as follows:
1. Crop the eye area according to the face landmarks points, right eye Point 36-41, left eye Point 42-47;
2. Use canny edge detection to identify the cornea area;
3. Calculate the average colour of the cornea except the pupil as the eye colour.

In a particular embodiment, the user's skin colour can be determined as follows:

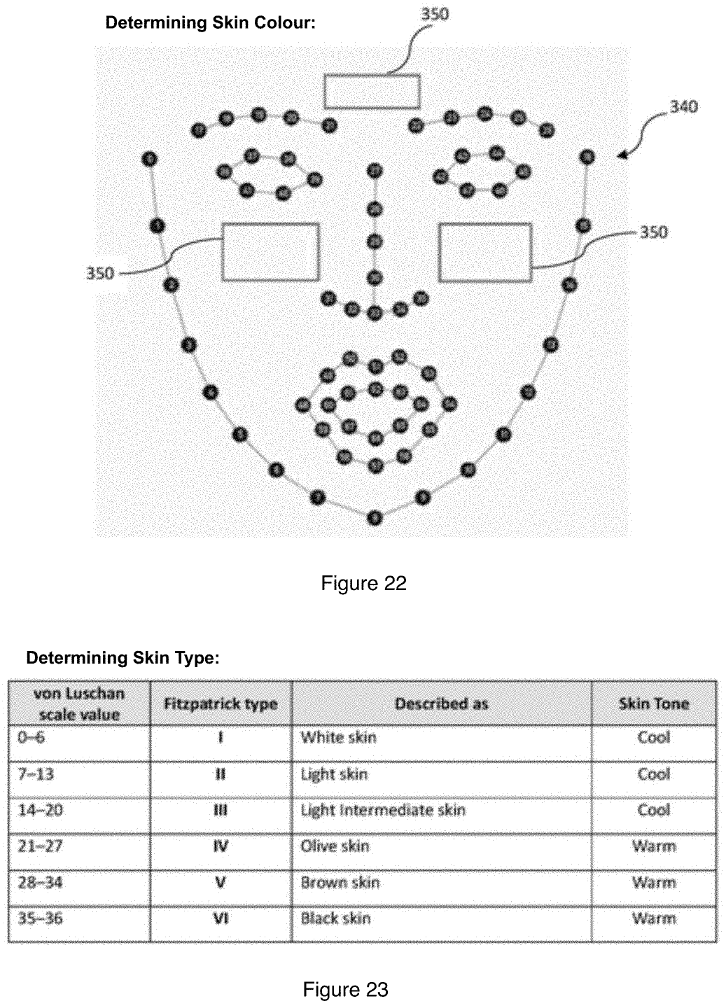

1. Crop three rectangle areas 350, as shown in FIG. 22, from the face according to the face landmarks points.

Right cheek: Rec(Point[36].X, Point[1].Y, Point[39].X, Point[2].Y)

Left cheek: Rec(Point[42].X, Point[15].Y, Point[45].X, Point[14].Y)

Forehead: Rec(Point[21].X, Point[21].Y−10, Point[22].X, Point[22].Y−30)

2. Collect the RGB colours of these 3 rectangle area into a RGB array
3. Calculate the average of the 3 areas' colour. The following formula may be used:

$$Face Color = \frac{1}{n} {\sum }_{k = 0}^{n} RGB [ k ]$$

4. Classify the skin colour according to Van Luschan scale and relate skin colour classification to skin tone in Fitzpatrick scale (See: Fitzpatrick T B: Soleil et peau [Sun and skin]. Journal de Medecine Esthetique 1975; 2:33-34; and, Nina Jablonski, Michael P. Muehlenbein (ed.) (2010). Human Evolutionary Biology. Cambridge University Press, p. 177. ISBN 0521879485)

Von Luschan's chromatic scale (otherwise known as ‘von Luschan scale’ or ‘von Luschan's scale’) is a method of classifying skin colour consisting of 36 colour categories. The thirty-six categories of the von Luschan scale can be related to six categories of the Fitzpatrick scale, which is a scale for classification of skin type.

As set out in the table of FIG. 23, Von Luschan scale ratings of 0-6, 7-13, and 14-20, can be correlated with Fitzpatrick types I, II, and III respectively, each of which is identified as a cool (light variant) skin tone. Von Lushan scale ratings of 21-27, 28-34, and 35-36, can be correlated to Fitzpatrick types IV, V, and VI respectively, each of which is identified as a warm (dark variant) skin tone.

Thus, skin tone may be identified by comparing face sample colour with the Von Luschan's chromatic scale in order to obtain the von Luschan scale value, and then relating Von Luschan's chromatic scale value to Fitzpatrick type in order to determine the skin tone as cool (light variant) or warm (dark variant).

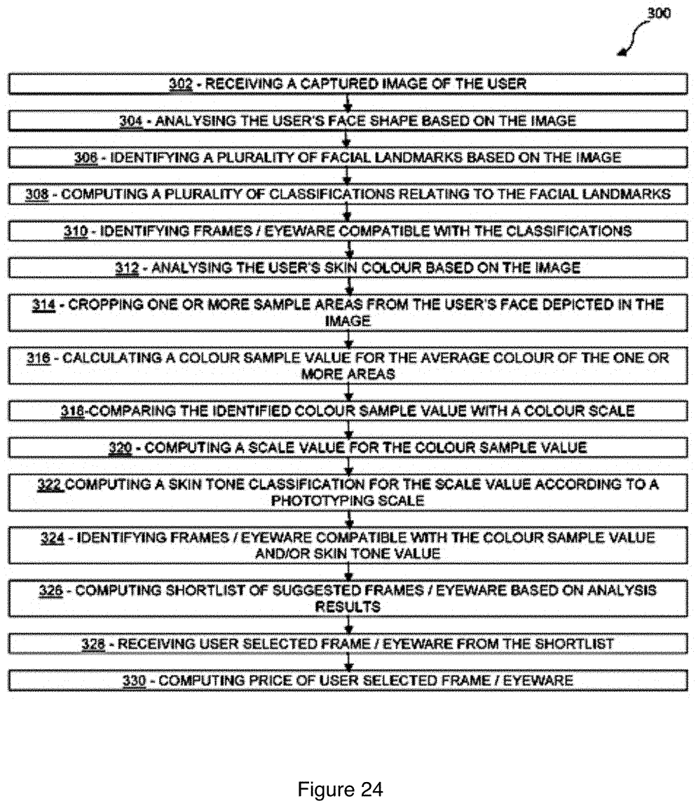

Referring now to FIG. 24, there is shown a computer-implemented method (300) for eyewear recommendation and sales according to a second embodiment of the invention in which user compatible frames are identified based on user image analysis. Some or all of the steps of the second method embodiment (300) can be incorporated or substituted into the first method embodiment (200), and vice versa.

At step 302, an image of the user is captured and the captured image is received by a processor. At step 304, analysis of the users face shape as depicted in the image is performed the processor. The face shape analysis involves: at step 306, identifying a plurality of facial landmarks based on the image; at step 308, computing a plurality of classifications relating to the facial landmarks; and at step 310, identifying frames (including eyeware with frames) compatible with the classifications. At step 312, analysis of the user's skin colour in the image is performed. The skin colour analysis involves: at step 314, cropping one or more sample areas from the user's face depicted in the image; at step 316, calculating a colour sample value for the average colour of the one or more cropped sample areas; at step 318, comparing the identified colour sample value with a colour scale; at step 320, computing a scale value for the colour sample value; at step 322, computing a skin tone value/classification for the scale value according to a phototyping scale; and at step 324, identifying frames (including eyeware with frames) compatible with the colour sample value and/or skin tone value. At step 326, a shortlist of compatible frames (including eyeware with frames) is computed based on face shape and/or skin colour analysis results. At step 328, frames (including eyeware with frames) selected from the shortlist by the user/user device are received at the processor. At step 330, the price of the user selected frames (including eyeware with frames) is computed.

In some embodiments, the method may further comprise displaying a simulation of a user-selected lens type on the user device for assisting the sales person with explaining various lens features or add-ons to the customer. The lens simulation may comprise interactive touch functionality implemented using a touch sensitive screen on the user device. Incorporating an interactive simulation advantageously serves to inform and educate the customer about the complexities of eyewear technology and can be leveraged efficiently as part of the sales process to influence the customer's behaviour and understanding. The ability to visualise in real time the improved effects of selected or shortlisted lens features may also facilitate upselling of lenses, while still ensuring that the lens is able to be fitted to the user-selected frame.

In some embodiments, the step of computing the shortlist of frames and/or the step of computing the shortlist of lenses may further comprise applying a predictive model to recommend similar items purchased previously by similar customers. For example, a predictive model may be developed using data obtained from past customer purchases and one or more of the user-specified criteria. The user's purchasing history, social profile, preferences and behaviours and demographic attributes of the user may be applied to the predictive model to estimate the likelihood of the user purchasing a specific type of product, to thereby refine the shortlist and present more relevant recommendations to the user.

In some embodiments, the step of computing the shortlist of frames and/or the step of computing the shortlist of lenses may further comprise calculating a customer lifetime value (CLV) score for the user using data relating to the customer's service and product purchasing history and providing this score to the sales person. This provides the sales person with valuable insight into the user's consumer behaviour and highlights the relevance of available frames, lenses and other product offerings to increase sales.

In some embodiments, the step of computing the shortlist of frames and/or the step of computing the shortlist of lenses may further comprise predictive analysis of the user's price sensitivity based on the user's purchasing history. The customer's price sensitivity may also be indicated on the user interface to assist the sales person with the sales process. For example, discreet colour bands may be displayed on the user interface corresponding to the user's price sensitivity. In other embodiments, the user's price sensitivity may additionally or alternatively be computed based on a predictive model data developed using data obtained from past and present customers, and the user-specified criteria, the user's purchasing history, demographic attributes, and social profile of the user may be applied to the predictive model to estimate the user's price sensitivity.

Embodiments of the present invention provide a system and method that are useful for assisting sales people with recommending, dispensing, and selling complex eyewear products and are significantly more effective and efficient than eyewear sales and selection processes currently used in optical product outlets. Further, embodiments of the present system and method that are configured for direct use by consumers are useful for streamlining and simplifying the decision-making process for consumers.

It will be appreciated that embodiments of the system and method described may provide effective communication interfaces between the sales person and the customer, which may be particularly useful for selling complex technical products such as eyewear products. The system and method may also provide for a structured and systematic sales process, to maintain a consistent customer experience across different staff members and different retail locations. The system and method may also reduce the frequency and occurrence of customer complaints and facilitates troubleshooting and complaint management. The system and method may also reduce the time required to train eyewear sales personal and provide them with the skills required to sell complex eyewear products from between one to two years down to approximately eight weeks.

Embodiments of the present system and method may also provide useful improvements to the traditional sales training model, and may assist with changing behaviour and ensuring compliance. For example, the present method may reduce training time of new sales staff to around 8 weeks. Further, the present method may also enable new technical products to be introduced seamlessly, with sales staff trained and able to sell the new products in a fraction of time compared to conventional training methods. Further, the present method may advantageously provide an ability to manage ongoing training of eyewear sales personal based on benchmark metrics formulated as part of the method leading to improvements in sales skills and performance.

Embodiments of the present system and method may also improve staff productivity by providing a sales process which is much more efficient and flexible compared to prior art processes, since the system automatically computes and presents not only the possible combinations of eyewear packages, but also updates the total price of the package substantially in real time.

Embodiments of the present system and method may also be used as a training tool in universities and other learning institutions and in developing countries where persons having the necessary skills, knowledge and experience to assist consumers with eyewear selection and procurement do not exist or are in short supply.

For the purpose of this specification, the word “comprising” means “including but not limited to”, and the word “comprises” has a corresponding meaning.

The above embodiments have been described by way of example only and modifications are possible within the scope of the claims that follow.

As described herein, a method involving implementation of one or more steps by computing devices should not necessarily be inferred as being performed by a single computing device such that the one or more steps of the method may be performed by more than one cooperating computing devices.

Objects such as ‘server’, ‘computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

One or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

The one or more processors may form a web appliance, a network router, switch or bridge, or any machine capable of executing a set of instructions (sequential or otherwise) that specify actions to be taken by that machine.

It will be understood that steps of methods discussed may be performed by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Some elements of methods described herein may be implemented by a processor or a processor device, computer system, or by other means of carrying out the function. Thus, a processor with the necessary instructions for carrying out such a method or element of a method forms a means for carrying out the method or element of a method.

Particular features, structures or characteristics or characteristics may be combined in any suitable manner, as would be apparent to one of ordinary skill in the art from this disclosure, in one or more embodiments/arrangements.

It should be appreciated that in the above description of example embodiments/arrangements of the invention, various features of the invention are sometimes grouped together in a single embodiment/arrangement, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment/arrangement. Thus, the claims following the Detailed Description are hereby expressly incorporated into this Detailed Description, with each claim standing on its own as a separate embodiment/arrangement of this invention.

Furthermore, while some embodiments/arrangements described herein may include some but not other features included in other embodiments/arrangements, combinations of features of different embodiments/arrangements are meant to be within the scope of the invention, and form different embodiments/arrangements, as would be understood by those in the art. For example, in the following claims, any of the claimed embodiments/arrangements can be used in any combination.

1: A method, comprising:
receiving, at a processor, a user's optical prescription;
receiving, at the processor, the user's frame preferences based on one or more user-specified criteria selected via a user device;
computing, by the processor, a shortlist of suggested frames based on the user's frame preferences;
displaying, on the user device, information relating to the shortlist of suggested frames;
receiving, at the processor, a user-selected frame selected from the shortlist of suggested frames via the user device;
receiving, at the processor, the user's lens preferences based on one or more user-specified criteria selected via the user device;
computing, by the processor, a shortlist of available lenses corresponding to the user's lens preferences, the user's optical prescription and suitability for fitting to the user-selected frame;
displaying, on the user device, the shortlist of lenses;
receiving, at the processor, user-selected lenses selected from the shortlist via the user device;
computing, by the processor, a total price of user-selected frame and user-selected lenses; and
displaying, on the user device, the total price,
wherein the user-specified criteria for computing frame preferences comprise one or more of frame style, user lifestyle, frame brand, intended use, age of user, comfort, frame material, frame durability, frame weight, frame size, user's health conditions, strength of prescription, frame price.

2: The method of claim 1, wherein the processor retrieves the user's optical prescription from a database.

3: The method of claim 1, wherein the processor receives the user's optical prescription from user input via the user device.

4: The method of claim 1, wherein the user-specified criteria for computing frame preferences comprise user's face shape, user's skin colour and other facial features of the user.

5: The method of claim 4, further comprising:
receiving, at the processor, a photograph of the user;
analysing, by the processor, the user's face shape and/or skin colour based on the photograph;
displaying analysis results of the user's face shape and/or skin colour; and
applying the analysis results when shortlisting the available frames.

6: The method of claim 5, wherein the analysis of face shape is computed by:
identifying a plurality of facial landmarks based on the photograph;
computing a plurality of classifications relating to the facial landmarks; and
identifying frames compatible with the classifications.

7: The method of claim 6, wherein the step of computing the shortlist of frames and/or the step of computing the shortlist of lenses further comprises predictive analysis of one or more of:
a) the user's price sensitivity based on the user's purchasing history;
b) the user's purchasing behaviours; and
c) the user's social preferences.

8: (canceled)

9: The method of claim 1, wherein the user-specified criteria for computing lens preferences comprise one or more of lens design, lens coating, lens material, lens thickness, lens price, lens tint, lens photochromic treatment, lens coatings, lens durability, lens edge finish, lens size, lens curve, lens power range, strength of prescription, user lifestyle, lens brand, intended use, age of user, comfort, and user's health conditions.

10: The method of claim 1, further comprising displaying, on the user device, a simulation of a user-selected lens type.

11: The method of claim 1, wherein the step of computing the shortlist of frames and/or the step of computing the shortlist of lenses further comprises applying a predictive model based on similar customers according to the user-specified criteria.

12: The method of claim 1, wherein the step of computing the shortlist of frames and/or the step of computing the shortlist of lenses further comprises predictive analysis of one or more of:
a) the user's price sensitivity based on the user's purchasing history;
b) the user's purchasing behaviours; and
c) the user's social preferences.

13-14: (canceled)

15: The method of claim 1, further comprising:
displaying, on the user device, one or more additional features available for the user-selected frame and/or user-selected lenses;
selecting, via the user device, one or more of the additional features;
re-computing, by the processor, an updated total price of user-selected frame and lenses together with the additional feature(s); and
displaying, on the user device, the updated total price.

16: A system, comprising:
a processor; and
a non-transitory computer-readable medium coupled to the processor and having instructions stored thereon, which, when executed by the processor, cause the processor to perform operations comprising:
receiving, at the processor, a user's optical prescription;
receiving, at the processor, the user's frame preferences based on one or more user-specified criteria selected via a user device;
computing, by the processor, a shortlist of suggested frames based on the user's frame preferences;
displaying, on the user device, the shortlist of frames;
receiving, at the processor, a user-selected frame selected from the shortlist via the user device;
receiving, at the processor, the user's lens preferences based on one or more user-specified criteria selected via the user device;
computing, by the processor, a shortlist of available lenses corresponding to the user's lens preferences, the user's optical prescription and suitability for fitting to the user-selected frame;
displaying, on the user device, the shortlist of lenses;
receiving, at the processor, user-selected lenses selected from the shortlist via the user device;
computing, by the processor, a total price of user-selected frame and user-selected lenses; and
displaying, on the user device, the total price.

17: A non-transitory computer-readable medium having instructions stored thereon, which, when executed by a processor, cause the processor to perform operations comprising:
receiving, at the processor, a user's optical prescription;
receiving, at the processor, the user's frame preferences based on one or more user-specified criteria selected via a user device;
computing, by the processor, a shortlist of suggested frames based on the user's frame preferences;
displaying, on the user device, information relating to the shortlist of suggested frames;
receiving, at the processor, a user-selected frame selected from the shortlist of suggested frames via the user device;
receiving, at the processor, the user's lens preferences based on one or more user-specified criteria selected via the user device;
computing, by the processor, a shortlist of available lenses corresponding to the user's lens preferences, the user's optical prescription and suitability for fitting to the user-selected frame;
displaying, on the user device, the shortlist of lenses;
receiving, at the processor, user-selected lenses selected from the shortlist via the user device;
computing, by the processor, a total price of user-selected frame and user-selected lenses; and
displaying, on the user device, the total price.

18-32: (canceled)

33: The method of claim 1, comprising:
receiving, at a processor, a photograph of a user;
analysing, by the processor, the user's face shape and/or skin colour based on the photograph; and
computing, by the processor, a shortlist of suggested frames based on results of the analysis of the user's face shape and/or skin colour.

34: The method of claim 33, wherein the analysis of face shape is computed by:
identifying a plurality of facial landmarks based on the photograph;
computing a plurality of classifications relating to the facial landmarks; and identifying frames compatible with the classifications.

35: The method of claim 34, wherein the facial landmarks include a hairline, jawline, skull shape, face shape, eye position, eye shape, eye colour, nose position, face height, face width and/or nose outline of the user.

36: The method of claim 34, wherein the classifications relating to face shape include oval, oblong, heart, square, round, diamond and/or triangle shaped; wherein the classifications relating to jawline include pointy, square and round; wherein the classifications relating to hairline include wide, intermediate and narrow; and wherein face shape is determined based on a face height to width comparison value, hairline classification, and jawline classification.

37-39: (canceled)

40: The method of claim 33, wherein the analysis of skin colour comprises:
cropping one or more sample areas from the photograph; and
calculating a colour sample value for the average colour of the one or more sample areas.

41: The method of claim 40, wherein the cropped sample areas are from the user's right cheek, left cheek, and forehead in the photograph.

42: The method of claim 40, wherein the analysis of skin colour further comprises:
comparing the identified colour sample value with a colour scale; and
computing a scale value for the colour sample value.

43-62: (canceled)
